(19) United States
(12) Patent Application Publication
(10) Pub. No.: US 2006/0073813 A1
(43) Pub. Date: Apr. 6, 2006

(54) Method and system of a voice recording device and a mobile computing device

(76) Inventor: Bernhard Reus, Grafenau (DE)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/959,461

(22) Filed: Oct. 6, 2004

(51) Int. Cl. H04L 12/58

(52) U.S. Cl. 455/412.1

(57) ABSTRACT

A method and system of a voice recording device and a mobile computing device. Some of the exemplary embodiments may be a method comprising creating a voice recording with a voice recording device at least partially within a chassis of a mobile computing device (the creating while the mobile computer device is powered-off), and powering-on the mobile computing device.

### BACKGROUND

Mobile personal computer devices, sometimes equivalently referred to as laptop computers or notebook computers, make it possible for computer system users to access personal computer functionality while away from the home and/or office, and also in remote locations where sources of power may be difficult to find.

For a mobile personal computer device to be useful, however, it must be in an operational state. Thus, before a user may enter or retrieve information, the computer needs to be powered-on, its boot sequence complete and the operating system and/or application programs operational. Booting of a mobile computing device may take from several seconds to several minutes, depending on factors such as the type of operating system, the amount of random access memory, the size of the hard drive, the speed of the processor, and whether the device was properly powered-off in the last sequence.

If the mobile computer device is powered-off, and the user needs to input information, it may be inconvenient to boot the entire machine, especially if there is only a relatively small amount of information.

### SUMMARY

Thus, what is needed in the art is a mechanism to store information for later entry when the mobile computing device is powered-off.

The problems noted above are solved in large part by a method and system of a voice recording device and a mobile computing device. Some of the exemplary embodiments may be a method comprising creating a voice recording with a voice recording device at least partially within a chassis of a mobile computing device (the creating while the mobile computer device is powered-off), and powering-on the mobile computing device.

### BRIEF DESCRIPTION OF THE DRAWINGS

For a detailed description of exemplary embodiments of the invention, reference will now be made to the accompanying drawings in which:

FIG. 1 shows a mobile computing system in accordance with at least some embodiments of the invention;

FIG. 2 shows an electrical interconnection of a voice recording device and a mobile computing system in accordance with at least some embodiments of the invention;

FIG. 3 shows an electrical interconnection of a voice recording device and a mobile computing system in accordance with alternative embodiments of the invention; and

FIG. 4 shows a flow diagram in accordance with at least some embodiments of the invention.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function.

In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection, or through an indirect connection via other devices and connections.

### DETAILED DESCRIPTION

FIG. 1 illustrates a mobile computing device 100 in accordance with at least some embodiments of the invention. The mobile computing device comprises a plurality of user interfaces, such as a pointing device 10 and keyboard 12. So that the information may be conveyed to a user, the mobile computing device 100 also comprises a monitor 14 (viewable portion of the monitor not visible in FIG. 1; the device is shown partially closed). The computer system 100 may also comprise one or more speakers 16, which convey audio information to the user when the mobile computing device 100 is booted and operational.

In accordance with embodiments of the invention, the mobile computing device 100 may also comprise a voice recording system within the same chassis as the mobile computing device 100, and that is operational even when the mobile computing device 100 is powered-off. FIG. 1 simultaneously illustrates two alternative locations for a user interface of the voice recording system. In some embodiments, a user interface 18 is placed on a top cover housing the monitor 14. Thus, a user may selectively record, stop, play, fast forward and/or rewind voice recordings using the interface 18. In alternative embodiments, a user interface 20 is placed on a front surface 22 of the mobile computing device 100. The alternative user interface 20 may have the same functionality as discussed with respect to user interface 18. Although FIG. 1 only illustrates user interfaces for the voice recording system on the top cover that houses the monitor 14 and on the front face 22, it will be understood that the user interface for the voice recording system could be placed at any location on the mobile computing device 100, such as the bottom, back or sides. The user interfaces may be fully embedded, partially embedded or mechanically coupled to their respective cover or face.

A microphone for use with the voice recording system may be placed at any suitable location. FIG. 1 illustrates a first microphone 24 proximate to the user interface 18 on the top cover that houses the monitor 14. In alternative embodiments, a microphone 26 is placed on the front face 22 of the mobile computing device, possibly proximate to the user interface 20 for the voice recording system. Microphone 26 may be used alone when the user interface 18 is used. Likewise, microphone 24 may be used alone when interface 20 is used. Both microphones 24 and 26 could be embedded in the chassis and have relevant portions extending through the surface at desired locations. Alternatively, the microphones 24 and 26 could be within the chassis with respective apertures in the chassis to allow sound to reach the microphone.

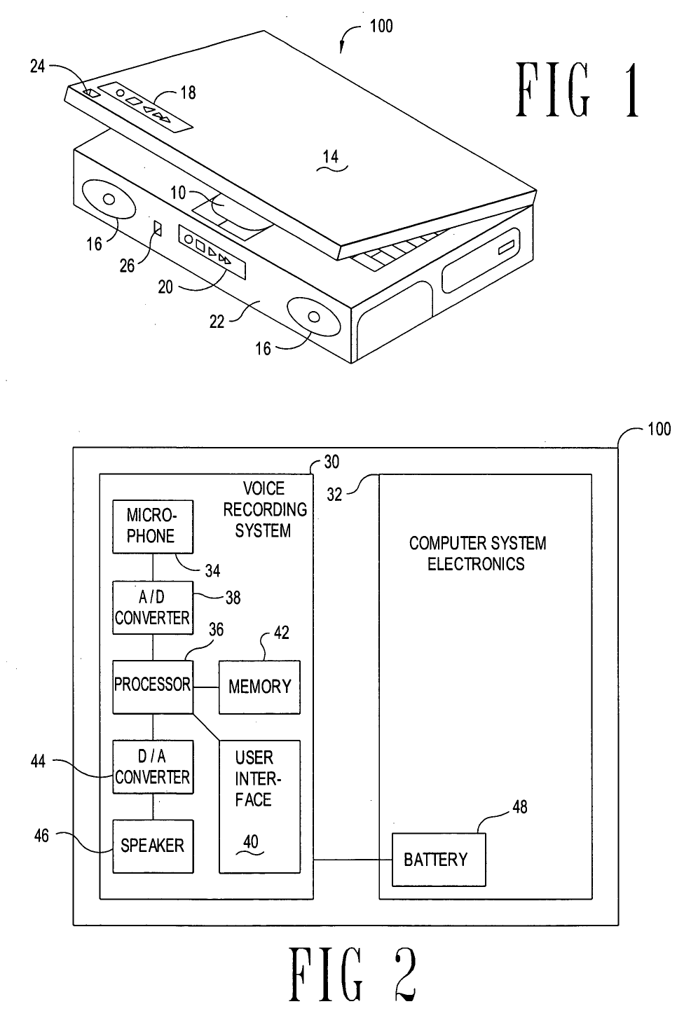

The degree of interaction and/or commonality of components between the voice recognition system and the computer system electronics with which it is integrated may vary significantly across embodiments of the invention. FIG. 2 illustrates, in block diagram form, a mobile computing system 100 having an integrated voice recording system 30 that is only minimally coupled to and dependent upon the computer system electronics 32. In particular, voice recording system 30, in accordance with at least some embodiments of the invention, comprises its own microphone 34 coupled to a processor 36 by way of an analog/digital (A/D) converter 38. The processor 36 may be any suitable processor, such as a microcontroller or a digital signal processor. Taking commands from the user interface 40, the processor may sample the spoken words of the user detected by the microphone, and store a digital representation of those spoken words in the memory 42. Memory 42 may be any suitable memory such as random access memory (RAM), nonvolatile RAM (NVRAM) or any device suitable for storing digital voice recordings. Likewise at the direction of the user by way of the user interface 40, the processor 36 in the embodiments illustrated in FIG. 2 may read previously stored voice recordings from the memory 42, and provide the digital representations of those voice recordings to the digital-to-analog (D/A) converter 44 which in turn couples the analog signals produced to a speaker 46.

As illustrated in FIG. 2, the voice recording system 30, though integrated within the mobile computing device 100, is a standalone system having its own microphone and speakers, and relying on the computer system electronics 32 only to provide operational power from battery 48. Thus, in these embodiments the voice recording system 30 is utilized independent of the operational state of the computer system electronics 32. For example, the computer system electronics 32 may be powered-off, yet the voice recording system 30 may be activated by the user to store information in the form of digital voice recordings. Stated otherwise, voice recording system 30 is operational and draws power from battery 48 even when the computer system electronics 32 are powered-off. When a user of the system of the embodiments illustrated in FIG. 2 wishes to input the previously recorded data into the computer, the user may be required to boot the computer system electronics 32, play the previously recorded audio using, e.g., speaker 46, and then type the information into the computer system electronics, possibly by way of the keyboard 12 (FIG. 1).

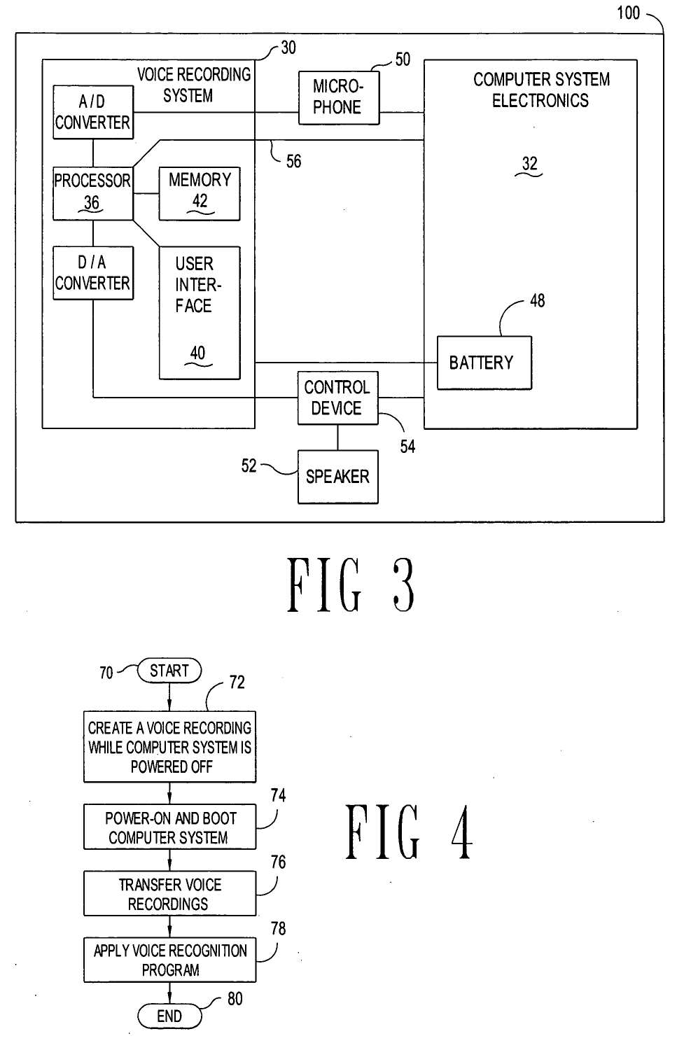

In alternative embodiments of the invention, the integrated voice recording system 30 is functionally coupled to the computer system electronics 32. In these alternative embodiments the voice recording system 30 may, in addition to the battery 48, share some common hardware components. FIG. 3 illustrates alternative embodiments of the invention where the voice recording system may be functionally coupled to the computer system electronics, and also where at least some commonly needed hardware elements may be shared as between them. In particular, FIG. 3 illustrates a mobile computing system 100 comprising a voice recording system 30 and computer electronics 32. In FIG. 3 however, the voice recording system 30 and computer electronics 32 share a microphone 50 and speaker 52. When the computer system electronics 32 are powered-off, the voice recording system 30 may use both the microphone 50 and speaker 52 as if they were dedicated hardware of the voice recording system. When the computer system electronics 32 are powered-on, both the voice recording system 30 and computer system electronics 32 may read and digitize sounds detected by the microphone 50. In the case of the shared speaker 52, control device 54 may control access to the speaker 52 by the voice recording system 30 and the computer system electronics 32. In some embodiments, control device 54 may be a relay that selectively couples one of the voice recording system 30 or computer system electronics 32 to the speaker or speakers 52. For example, the control device 54 may detect an audio signal generated by the voice recording system 30, and couple that signal to the speaker 52. When no audio signal is being produced by the voice recording system 30, the control device 54 may couple the speaker or speakers 52 to the computer system electronics 32. In alternative embodiments, the control device 54 may act as a mixer, mixing signals from both the voice recording system 30 and the computer system electronics 32 to be applied to the speaker 52. Much like the embodiments illustrated in FIG. 2, the voice recording system 30 of FIG. 3 operates and draws power from the battery 48 of the computer system electronics 32 even when the computer system electronics 32 are powered-off.

FIG. 3 also illustrates further illustrates embodiments where the processor 36 is communicatively coupled to the computer system electronics 32, such as by communication bus 56. In embodiments where the processor 36 communicatively couples to the computer system electronics 32, it is envisioned that voice recordings may be made by the voice recording system 30, drawing power from battery 48, while the computer system electronics 32 are powered-off. When the computer system electronics 32 are booted, the voice recordings stored in the memory 42 may be electronically transferred across the communication bus 56 to the computer system electronics 32.

FIG. 4 illustrates a method that may be implemented in accordance with at least some embodiments of the invention. The method starts (block 70) and proceeds to creating a voice recording, possibly by the voice recording system 30 while the computer system is powered-off (block 72). After one or more voice recordings are made, the computer system electronics 32 are powered-on and booted (block 74). After booting of the computer system electronics 32, the voice recordings are transferred from the voice recording system 30 to the computer system electronics 32 (block 76). The transfer may take many forms. In some embodiments, the user may replay the voice recordings, and somewhat simultaneously supply the information to the computer system by way of the keyboard 12 (FIG. 1). In alternative embodiments, transfer of the voice recordings may take place electronically, such as by processor 36 transferring files containing the digital voice recordings across the communication bus 56. In cases where the computer system electronics 32 receive an electronic version of the voice recordings, the voice recordings may be applied to voice recognition programs (block 78). Thereafter, the process ends (block 80).

Any suitable voice recognition program may be used in accordance with embodiments of the invention, and the text created by the voice recognition program inserted into user programs, such as a Word document and/or an Outlook entry. For example, the digital voice recording is applied to a voice recognition program operational with Word, and thus the transcribed message is placed directly into a Word file. If Word is not the final destination of the transcribed information, the text may be cut and pasted into other user programs. Alternatively, the information may transcribed by a voice recognition software directly into any currently available, or after-developed, user program.

In yet further alternative embodiments, after transfer of the digital voice recording, the computer system 32 may be used to transcribe the voice recordings manually, or the voice recordings may be forwarded, such as by an electronic mail message, to a person responsible for transcribing such messages.

From the description provided herein, those skilled in the art are readily able to combine software created as described with appropriate general purpose or special purpose computer hardware to create a computer system and/or computer subcomponents embodying the invention, to create a computer system and/or computer subcomponents for carrying out the method of the invention, and/or to create a computer-readable media storing a software program to implement the method aspects of the invention.

Thus, the various embodiments of the invention integrate both the functionality of the voice recording system, similar to a DICTAPHONE, as well as a mobile computing system, yet the voice recording functionality is not constrained to use only at times when the computer system electronics are powered-on and operational.

What is claimed is:

1. A method comprising:
creating a voice recording with a voice recording device at least partially within a chassis of a mobile computing device, the creating while the mobile computing device is powered-off; and
powering-on the mobile computing device.

2. The method as defined in claim 1 further comprising transferring at least some information from the voice recording to the mobile computing device.

3. The method as defined in claim 2 further comprising, after transferring, applying the voice recording to a voice recognition program executed by the mobile computing device.

4. The method as defined in claim 1 wherein creating further comprises creating a digital voice recording.

5. The method as defined in claim 4 wherein transferring further comprises electronically transferring the digital voice recording from the voice recording device to the mobile computer device.

6. The method as defined in claim 4 further comprising applying the digital voice recording to a voice recognition program executed by the mobile computing device.

7. The method as defined in claim 1 wherein creating further comprises creating the voice recording with a voice recording device at least partially within the chassis of a laptop computer.

8. A system comprising:
a mobile computer system comprising a battery, the mobile computer system contained within a chassis; and
a voice recording system at least partially contained within the chassis and electrically coupled to the battery,
wherein the voice recording system makes voice recordings using power from the battery when the mobile computer system is powered-off.

9. The system as defined in claim 8 wherein the voice recording system further comprises a recording system user interface electrically coupled to a processor.

10. The system as defined in claim 9 wherein the chassis further comprises a top cover that rotates about a hinge, and wherein the recording system user interface mechanically couples in the top cover.

11. The system as defined in claim 9 wherein the chassis further comprises:
a top cover that rotates about a hinge; and
a front face substantially normal to a plane of the top cover when the top cover is in a closed position, the front face opposite the hinge;
wherein the recording system user interface mechanically couples in the front face.

12. The system as defined in claim 8 wherein the voice recording system further comprises a microphone.

13. The system as defined in claim 12 wherein the microphone also electrically couples to the mobile computer system, wherein both the voice recording system and the mobile computer system are each operable to utilize the microphone.

14. The system as defined in claim 8 wherein the voice recording system further comprises a speaker.

15. The system as defined in claim 14 wherein the speaker also electrically couples to the mobile computer system, wherein both the voice recording system and the mobile computer system are each operable to utilize the speaker.

16. The system as defined in claim 8 wherein a processor of the voice recording system couples to the mobile communication system by way of a communication bus, and wherein the processor transfers voice recordings to the mobile computer system after the mobile computer system is powered-on.

17. The system as defined in claim 16 wherein the mobile computer system applies the voice recordings to at least one voice recognition program.

18. A notebook computer comprising:
a means for executing personal computer application programs, the means for executing at least partially contained within a chassis, and the means for executing couples to a battery; and
a means for recording sound at least partially contained within the chassis and coupled to the battery;
wherein the means for recording makes sound recordings when the means for executing is not in an operational state, and uses power from the battery.

19. The system as defined in claim 18 further comprising a microphone means electrically coupled to the means for recording.

20. The system as defined in claim 19 wherein the microphone means is also electrically coupled to the means for executing.

21. The system as defined in claim 18 further comprising a speaker means electrically coupled to the means for recording.

22. The system as defined in claim 21 wherein the speaker means also electrically couples to the means for executing.

23. The system as defined in claim 18 wherein the means for recording communicatively couples to the means for executing, and wherein, after a powering-on of the means for executing, the means for recording transfers sound recordings to the means for executing.

24. The system as defined in claim 23 wherein the means for executing applies the sound recordings to a means for voice recognition.

25. A computer-readable media storing a program that, when executed by a processor, implements a method comprising:
receiving at least a portion of a voice recording from a voice recording device coupled to the processor, and the voice recording device at least partially within a same chassis as the processor;
transcribing the voice recording to created transcribed text; and
placing the transcribed text into a user program.

26. The computer-readable media as defined in claim 25 wherein receiving further comprises receiving a digital voice recording.

27. The computer-readable media as defined in claim 25 wherein the sound recording is made while the processor is powered-off.

28. A method comprising:
creating a digital voice recording with a voice recording device at least partially within a chassis of a mobile computer device, the creating while the mobile computer device is powered-off; and then
powering-on the mobile computer device; and
transferring the digital voice recording from the voice recording device to a processor of the mobile computing device.

29. The method as defined in claim 28 further comprising supplying power to the voice recording device to make the digital voice recording from a battery of the mobile computing device.

30. The method as defined in claim 28 further comprising, after transferring, applying the digital voice recording to a voice recognition program executed by the processor of the mobile computing device.
